(19) United States
(12) Patent Application Publication
(10) Pub. No.: US 2016/0343352 A1
(43) Pub. Date: Nov. 24, 2016

(54) CONTROL UNIT AND METHOD FOR DYNAMICALLY CONTROLLING RESOLUTION OF DISPLAY

(71) Applicant: Arnab GANGULY, Bangalore (IN)

(72) Inventor: Arnab GANGULY, Bangalore (IN)

(73) Assignee: Wipro Limited, Bangalore (IN)

(21) Appl. No.: 14/788,691

(22) Filed: Jun. 30, 2015

(30) Foreign Application Priority Data
May 18, 2015 (IN) 2495/CHE/2015

(51) Int. Cl. G09G 5/22; H04N 21/4728

(52) U.S. Cl. CPC G09G 5/227; H04N 21/4728; G09G 2354/00; G09G 2320/08; G09G 2320/0606; G09G 2330/022

(57) ABSTRACT

Embodiments of present disclosure relate to a control unit and method for dynamically controlling resolution of a display associated to an electronic device. In some embodiments, at least one of contextual parameters and non-contextual parameters is received, one or more portions of the display requiring resolution adjustment is determined based on the at least one of the contextual parameters and the non-contextual parameters, a resolution to be applied for each of the one or more portions of the display is evaluated based on the at least one of the contextual parameters and the non-contextual parameters, and the evaluated resolution of each of the one or more portions of the display is provided to a graphic controller of the electronic device for controlling the resolution of the display.

### CROSS-REFERENCE TO RELATED APPLICATIONS

This U.S. patent application claims the benefit of priority under 35 U.S.C. §119 to India Patent Application No. 2495/CHE/2015, filed on May 18, 2015. The aforementioned application is incorporated herein by reference in its entirety.

### DESCRIPTION

1. Technical Field

The present subject matter is related, in general to display screens and more particularly, but not exclusively to a control unit of an electronic device and a method for dynamically controlling resolution of a display associated to an electronic device.

2. Background

In general, display screens are utilized to display information in visual form. For example, the display screens display one or more contents, like icons, pictures, images, texts, videos etc. in visual form for user view. Typically, the display screens have a desired resolution quality which depends on pixel density of the corresponding display screens. Also, the resolution quality of each display screen depends on user eye perception. Particularly, the resolution quality of each display screen depends on how the user percepts one or more portions of the display screen and/or the one or more contents displayed on the display screen. Presently, the resolution quality is controlled in a uniform way throughout the one or more display screens. For example, considering the resolution quality is set to 1080 pixels (p). Then, the entire display screen is set to have 1080p uniformly. In a scenario, the one or more portions which are never used or viewed by the user are still displayed with same resolution quality. In such a case, power consumption and processing power to display the one or more portions, which are not being viewed by the user, with uniform resolution quality is wasted.

In a scenario, consider the user wishes to view the one or more portions with high resolution quality and other portions of the display screen with low resolution quality. However, such a way of rendering the one or more portions with high resolution quality independent of other portions with low resolution quality is not possible in present approach since the resolution quality is set uniformly throughout the display screen.

The display screens using high resolution quality consume high battery life or power of a device associated to the corresponding display screen. For example, processing power and power consumption of the device increases exponentially when game applications and video are displayed in 1080p as compared to displaying the game applications and video in 720p. Such high power consumption is detrimental to battery life of the device associated to the corresponding display screen which results in low battery life.

Consider a scenario, where the user switches ON the display screen of the device. Assuming, the user is not using the device or not viewing the display screen after a while and keeps the display screen idle. In such a case, the power consumption and processing power is continuously wasted since the display screen is using a certain resolution quality even when the user is not viewing the display screen.

### SUMMARY

Disclosed herein is a method for dynamically controlling resolution of a display associated to an electronic device. The method comprises receiving at least one of contextual parameters and non-contextual parameters. Then, the method comprises determining one or more portions of the display requiring resolution adjustment based on the at least one of the contextual parameters and the non-contextual parameters. The method comprises evaluating resolution to be applied for each of the one or more portions of the display based on the at least one of the contextual parameters and the non-contextual parameters. The method comprises providing the evaluated resolution of each of the one or more portions of the display to a graphic controller of the electronic device for controlling the resolution of the display.

In an aspect of the present disclosure, a control unit of an electronic device for dynamically controlling resolution of a display associated to the electronic device is disclosed. The electronic device comprises a processor and a memory communicatively coupled to the processor. The memory stores processor-executable instructions, which, on execution, cause the processor to receive at least one of contextual parameters and non-contextual parameters. Then, the processor determines one or more portions of the display requiring resolution adjustment based on the at least one of the contextual parameters and the non-contextual parameters. The processor evaluates resolution to be applied for each of the one or more portions of the display based on the at least one of the contextual parameters and the non-contextual parameters. The processor provides the evaluated resolution of each of the one or more portions of the display to a graphic controller of the electronic device for controlling the resolution of the display.

In another aspect of the present disclosure, a non-transitory computer readable medium for controlling resolution of a display associated with an electronic device is disclosed. The non-transitory computer readable medium includes instructions stored thereon that when processed by a processor causes receiving at least one of contextual parameters and non-contextual parameters. Then, one or more portions of the display requiring resolution adjustment is determined based on the at least one of the contextual parameters and the non-contextual parameters. The resolution to be applied for each of the one or more portions of the display is evaluated based on the at least one of the contextual parameters and the non-contextual parameters. Then, the evaluated resolution of each of the one or more portions of the display is provided to a graphic controller of the electronic device for controlling the resolution of the display.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary diagram showing dynamic controlling of resolution of one or more portions of a display associated with an electronic device in accordance with some embodiments of the present disclosure;

FIG. 2a illustrates an exemplary environment having electronic device with control unit and graphic controller been associated to a display and communicatively connected to one or more sources in accordance with some embodiments of the present disclosure;

FIG. 2b illustrates an exemplary environment having electronic device with control unit, graphic controller and a display communicatively connected to one or more sources in accordance with some embodiments of the present disclosure;

FIG. 3 illustrates a block diagram of an electronic device having control unit comprising an I/O interface, a processor and a memory in accordance with some embodiments of the present disclosure;

FIG. 4 illustrates a block diagram of an exemplary electronic device having control unit with various data and modules for dynamically controlling resolution of a display in accordance with some embodiments of the present disclosure;

FIGS. 5a to 5d show block diagram of an exemplary display inputted with user gestures in accordance with some embodiments of the present disclosure;

FIG. 6 shows an exemplary diagram illustrating calculation of pixel coordinates of display in accordance with some embodiments of the present disclosure;

FIG. 7 shows a flowchart illustrating a method for dynamically controlling resolution of a display in accordance with some embodiments of the present disclosure; and

FIG. 8 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

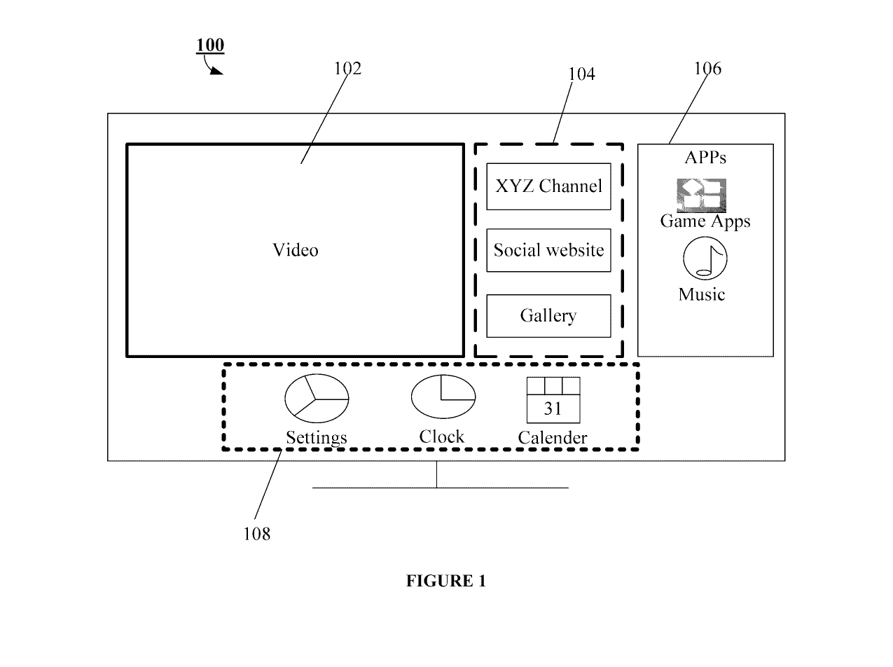

Embodiments of the present disclosure are related to a method for dynamically controlling resolution of a display associated to an electronic device by a control unit of the electronic device. FIG. 1 shows an exemplary diagram illustrating dynamic control of resolution of one or more portions of the display 100. From the illustrated FIG. 1, consider the display 100 displays one or more contents such as video 102, menu list 104 comprising XYZ channel, social website and gallery, program applications list 106 comprising game application and music application being downloaded and/or in-built in the electronic device, and other contents 108 such as settings, clock and calendar. The method comprises receiving contextual parameters and/or non-contextual parameters from one or more sources which are communicatively connected to the control unit and/or to the display 100. The contextual parameters and the non-contextual parameters are received in order to control resolution of the one or more portions of the display 100 and/or the entire display 100 itself. The one or more sources from where the contextual parameters and the non-contextual parameters are received comprise camera, sensors, battery life detectors, coordinate evaluators, etc. The one or more sources are configured on the display 100 and/or on the electronic device. The contextual parameters comprise user parameters, ambient parameters and content parameters. The user parameters includes, without limitations, user gestures performed on the display 100, information of the display 100 and/or the one or more portions of the display 100 being viewed by users, number of the users viewing the display 100 and distance value of the users with respect to the display 100. The user gestures can be predefined gestures pattern and/or uneven gesture patterns on the display 100. The ambient parameters include, without limitations, lighting conditions of environment around the display 100. The content parameters include, without limitations, content being viewed by users, and content being displayed on the display 100. The non-contextual parameters include, without limitations, power usage parameters and predefined resolution settings. The power usage parameters comprise information of power consumption of the display 100 and/or an electronic device associated to the display 100. The predefined resolution settings comprise preferences of user for viewing the one or more areas of the display 100 and the content displayed on the display 100.

Then, the method comprises determining one or more portions of the display 100 requiring resolution adjustment based on the contextual parameters and/or the non-contextual parameters. The one or more portions of the display 100 requiring resolution adjustments are determined by measuring coordinates of each portion of the one or more portions. Then, the method comprises evaluating resolution to be applied for each of the one or more portions of the display 100 based on the at least one of the contextual parameters and the non-contextual parameters. For example, if the user performs some gesture patterns on the display 100 then the portions formed from the gesture patterns are selected. Then, the resolution of the selected portions is modified. If the display is being viewed by the user and/or the one or more portions are being viewed by the user, then the display 100 and/or the one or more portions being viewed by the user are selected. Then, the resolution of the display 100 itself and/or the one or more portions are modified. For example, if the display 100 and/or the one or more portions are not being viewed by the user, then the resolution of the display 100 and/or the one or more portions are reduced. The modification of the resolution of the display 100 and/or the one or more portions also depends on the number of users viewing the display 100 and/or the one or more portions. For example, if no user is present in front of the display 100 or if no user is viewing the display then the resolution of the display 100 is reduced or the display 100 is shut off. The resolution of the display 100 and/or the one or more portions also depends on the distance value of the users from the display 100. For example, if the users are present beyond a certain distance limit then the resolution of the display 100 and/or the one or more portions is reduced to low resolution. When the user is close to the display 100 then the resolution of the display 100 is set to high resolution. The resolution would be adjusted without impacting the viewing experience of the user/s. If the lighting condition of environment around the display 100 is bright or dark then the resolution of the display 100 is adjusted as per user's eye perception. If a particular content is being regularly viewed by the user and/or displayed on the display 100, then the resolution of the particular content is adjusted to be more for user's visibility. If the power consumed by the display 100 and/or the electronic device is more, then the resolution of the display 100 and/or the one or more portions which not viewed by the users are reduced. If the user has predefined preferences of resolution of each of the display 100 and/or each portion of the one or more portions and/or the content to be viewed, then the resolution of each of the display 100 and/or each portion of the one or more portions and/or the content to be viewed is modified. Hence, based on the above mentioned parameters, the resolution to be applied for each of the one or more portions and/or the display 100 is evaluated. The evaluated resolution to be applied is provided to a graphic controller of the electronic device for dynamically controlling the resolution of the one or more portions and/or the display 100. The graphic controller can be configured in the display 100 itself.

In the illustrated FIG. 1, the resolution of the one or more portions comprising the video 102, the menu list 104, the program application list 106 and the other portions 108 is modified based on the above mentioned parameters. For example, the video portion resolution is increased whereas the resolution of rest of the one or more portions is decreased. In such a way, the resolution of the one or more portions of the display 100 is controlled where uniformity of the resolution throughout the display is eliminated. Also, the resolution is controlled based on parameters.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

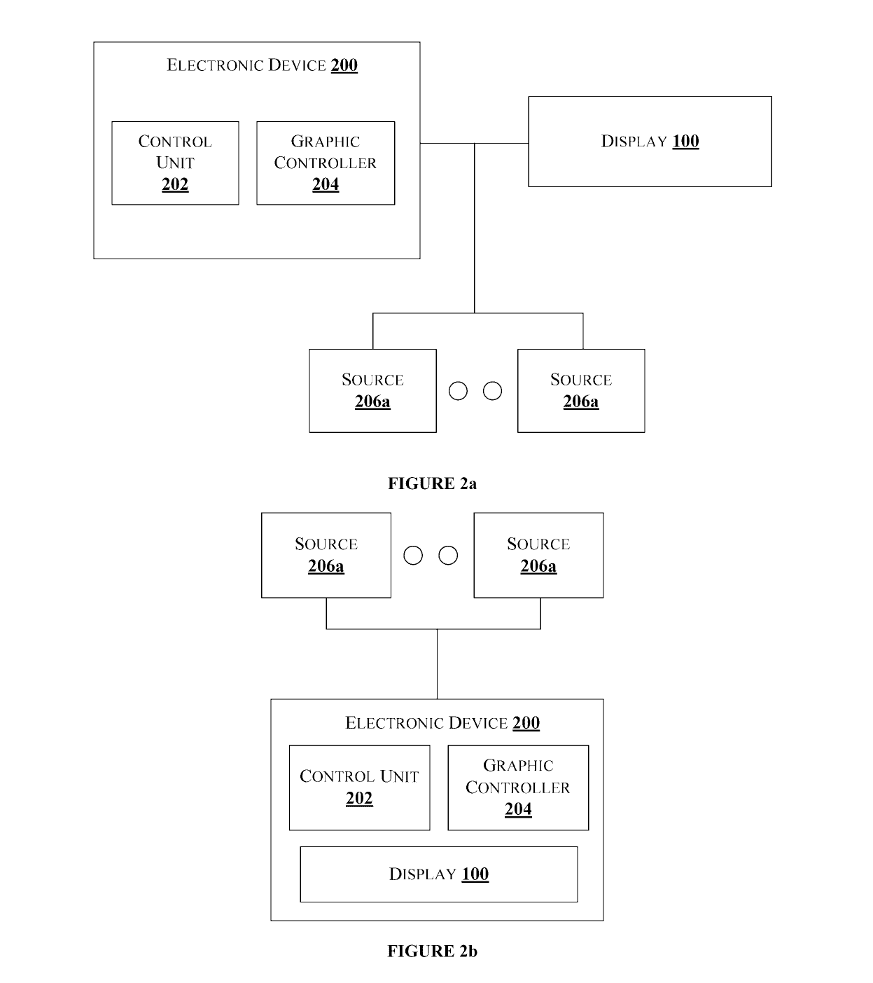

FIG. 2a illustrates an exemplary environment having an electronic device 200 with a control unit 202 and a graphic controller 204 been associated to a display 100 and communicatively connected to one or more sources 206a, . . . , 206n (collectively referred to 206) in accordance with some embodiments of the present disclosure.

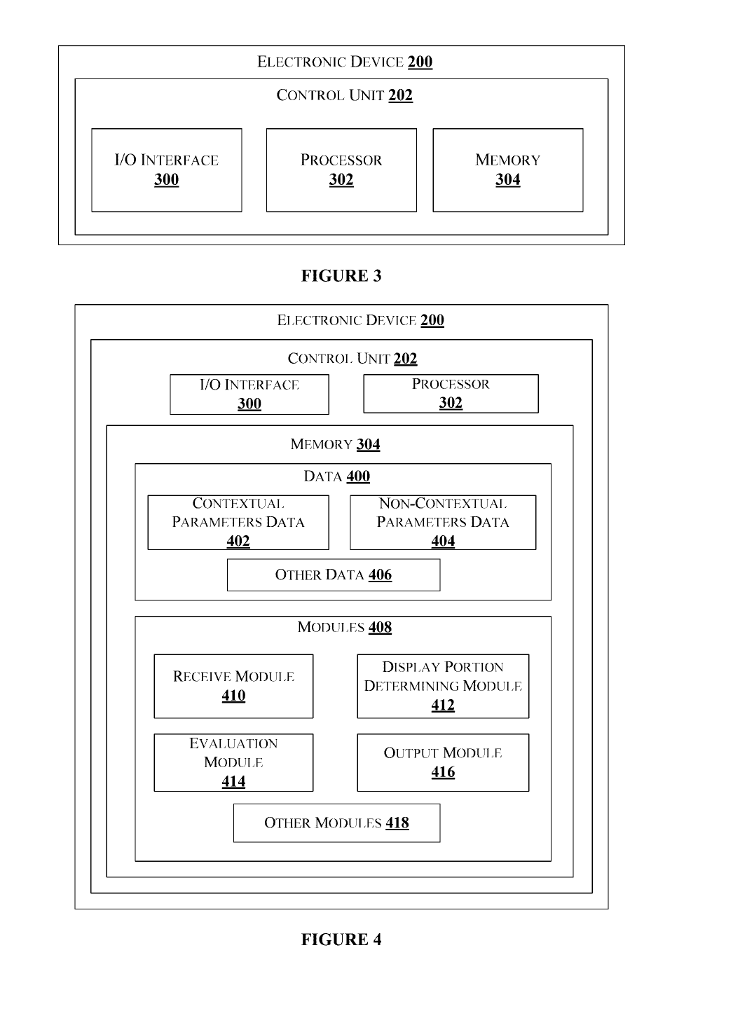

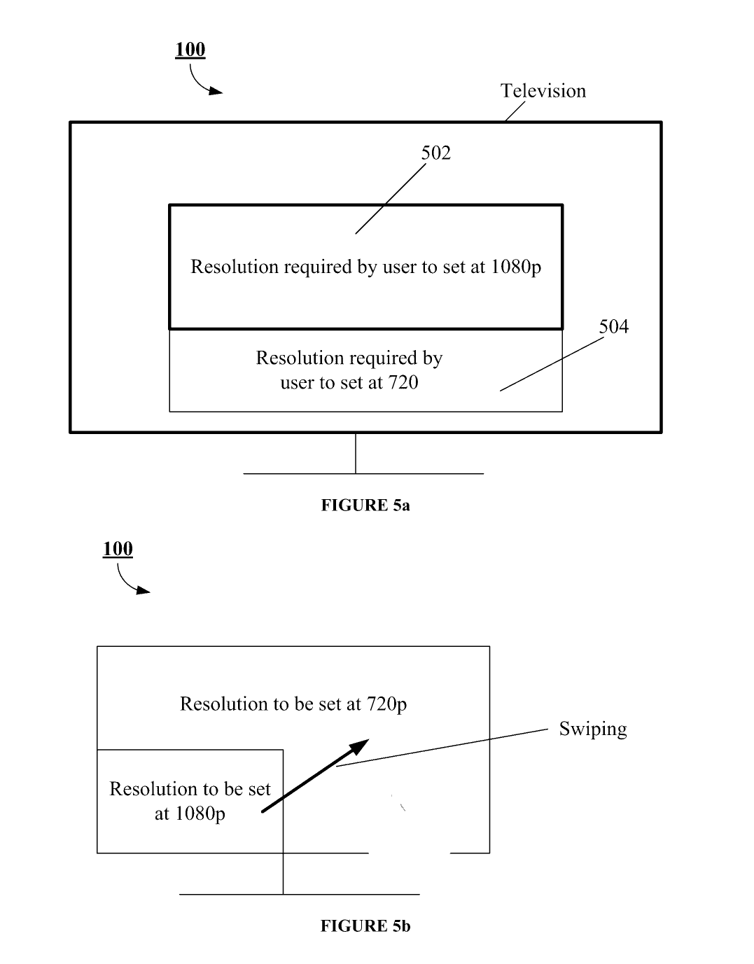

Examples of the electronic device 200 includes, but is not limited to, mobile phone, ATM machine, television, digital television, laptop, tablet, desktop computer, Personal Computer (PC), contactless device, Personal Digital Assistants (PDAs), smartwatch, notebook, audio- and video-file players (e.g., MP3 players and iPODs), and e-book readers (e.g., Kindles and Nooks), smartphone, wearable device, digital cameras, synthesizers, video games, scientific instrumentation, industrial robotics, medical electronics and the like. In an embodiment, the electronic device 200 is associated to the display 100. Particularly, the electronic device 200 is connected to the display 100 through communication network including, without limitations, wired network and/or wireless network which are explained in detail in following description. The display 100 includes, without limitation, dashboards, billboards, hoardings, network metric displays, etc. In one implementation, the display 100 refers to a display screen which is utilized to display information in visual form. In an embodiment, the display 100 displays one or more contents, for example icons such as menu list, applications i.e. software applications being downloaded or in-built within the display 100 and/or the electronic device 200, pictures, images, texts, videos etc. in visual form for user view. Each display 100 comprises a plurality of pixels which defines the resolution of the one or more portions of the display 100 and/or the entire display 100 itself. The resolution of the one or more portions of the display 100 and/or the entire display 100 is set by the graphic controller 204 configured in the associated electronic device 200. Particularly, the graphic controller 204 sets the resolution along with color depth of each pixel of the plurality of pixels corresponding to the one or more portions of the display 100 and/or the entire display 100. In an embodiment, the graphic controller 204 can be configured in the display 100 itself. In an embodiment, the electronic device 200 comprises the control unit 202 which is configured to perform dynamic control of resolution of the one or more portions of the display 100 and/or the display 100 itself. In an embodiment, the control unit 202 comprises one or more components, data and modules which are responsible to perform the dynamic control of resolution of the one or more portions and/or the display 100. The one or more components, the data and the modules contained in the control unit 202 are explained in detail in FIGS. 3 and 4 of the following description.

The electronic device 200 is associated to the one or more sources 206. The one or more sources 206 include, without limitations, camera, sensors, content based sources, battery life detectors, and display based sources. In an embodiment, the camera and sensors are configured in the electronic device 200 and/or on the display 100 itself. The camera/sensors are configured to retrieve contextual parameters comprising user parameters, ambient parameters and content parameters. Particularly, the camera retrieves the user parameters including, without limitations, information of the display 100 and the one or more portions of the display 100 being viewed by the users, number of users viewing the display 100 and/or present in front of the display 100 and distance value of the users from the display 100. The camera/sensors are further configured to retrieve the ambient parameters including, without limitations, lighting conditions of environment around the display 100 and the content parameters including, without limitations, content being viewed by the users and content being displayed on the display 100. The camera is further configured to retrieve user emotions i.e. user responses while viewing the display 100 and/or the one or more portions of the display 100. The sensor is configured to sense or detect the user parameters comprising user gestures on the display 100. The sensors can detect predefined gesture patterns and/or uneven gesture patterns performed by the users on the display 100. The user gestures includes, but are not limited to, swipe, slide, poke, tap, press, pinch, gestures, movements, motions etc. and other such gestures which can be enabled by the display 100 and/or the electronic device 200. In an embodiment, the user gestures can be inputted using a marker which includes, but is not limited to, stylus, pen, pencil, hand, finger, and pointing device, etc.

The content based sources provide kinds of contents being displayed on the display 100 and/or viewed by the users. The battery life detectors detect non-contextual parameters comprising the power usage parameters which are related to battery life or power consumption of the electronic device 200 associated to the display 100 and/or the display 100 itself. The display device based sources provide predefined resolution settings involving preferences of users for viewing the one or more portions of the display 100 and/or the content being display on the display 100.

In an embodiment, the display 100 can be configured in the electronic device 200 as shown in FIG. 2b. For example, the mobile phone comprises a display which implies that the display is configured in the electronic device 200.

FIG. 3 illustrates a block diagram of the electronic device 200 having the control unit 202 comprising an I/O interface 300, at least one central processing unit (“CPU” or “processor”) 302, and a memory 304 in accordance with some embodiments of the present disclosure. The control unit 202 dynamically controls the resolution of the one or more portions of the display 100 and/or the entire display 100 based on the contextual parameters and/or the non-contextual parameters.

The I/O interface 300 is a medium through which the contextual parameters and/or the non-contextual parameters are received from the one or more sources 206. Particularly, the I/O interface 300 receives the contextual parameters including, without limitations, the user parameters, the ambient parameters, the content parameters along with the user emotions from the one or more sources 206. The I/O interface 300 receives the non-contextual parameters including, without limitations, the power usage parameters and the predefined resolution settings from the one or more sources 206. In an embodiment, a result of the resolution required to be adjusted for each of the one or more portions of the display 100 and/or the display 100 itself is provided to the graphic controller 204. In an embodiment, the I/O interface 300 is coupled with the processor 302.

The processor 302 may comprise at least one data processor for executing program components for executing user- or device-generated parameters for dynamically controlling resolution of the one or more portions of the display 100 and/or the display 100. The processor 302 is configured to determine the one or more portions of the display 100 requiring resolution adjustments based on the contextual parameters and/or the non-contextual parameters received from the one or more sources 206. The processor 302 determines the one or more portions of the display 100 requiring resolution adjustment by calculating the pixels coordinates on the display 100. The processor 302 is configured to evaluate resolution to be applied for each of the one or more portions of the display 100 based on the contextual parameters and/or the non-contextual parameters. The processor 302 provides the evaluated resolution of each of the one or more portions of the display 100 to the graphic controller 204 of the electronic device 200 and/or the display 100 for controlling the resolution of the display 100. The controlling of resolution of the one or more portions of the display 100 and/or the display 100 is performed by various modules which are explained in following description. The various modules are executed by the processor 302 of the control unit 202 of the electronic device 200.

The memory 304 stores instructions which are executable by the at least one processor 302. The memory 304 stores contextual parameters data related to the contextual parameters and non-contextual parameters data related to the non-contextual parameters. In an embodiment, the contextual parameters data and the non-contextual parameters data are stored as one or more data required for dynamically controlling resolution of the one or more portions of the display 100 and/or the display 100. The one or more data are described in the following description of the disclosure.

FIG. 4 illustrates a block diagram of the exemplary electronic device 200 having the control unit 202 with various data and modules for dynamically controlling resolution of the display 100 in accordance with some embodiments of the present disclosure. In the illustrated FIG. 4, the one or more data 400 and the one or more modules 408 stored in the memory 304 are described herein in detail.

In an embodiment, the one or more data 400 may include, for example, the contextual parameters data 402, the non-contextual parameters data 404 and other data 406 for dynamically controlling resolution of the one or more portions of the display 100 and/or the display 100.

The contextual parameters data 402 is related to the contextual parameters which includes, but is not limited to, the user parameters, the ambient parameters and the content parameters along with the user emotions i.e. responses of the user towards viewing the one or more portions, and/or the content and/or the display 100.

The non-contextual parameters data 404 is related to the non-contextual parameters which includes, but is not limited to, the power consumption and the predefined resolution settings. The power consumption information is associated to the display 100 and/or the electronic device 200 and the predefined resolution settings which comprise the preferences of the user for viewing the one or more portions of the display 100 and the content being displayed on the display 100.

The other data 406 may refer to such data which can be associated to the display 100 and/or the electronic device 200 for controlling the resolution of the one or more portions and the display 100.

In an embodiment, the one or more data 400 in the memory 304 are processed by the one or more modules 408 of the control unit 202 of the electronic device 200. The one or more modules 408 may be stored within the memory 304 as shown in FIG. 4. In an example, the one or more modules 408, communicatively coupled to the processor 302, may also be present outside the memory 304 and implemented as hardware. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In one implementation, the one or more modules 408 may include, for example, a receive module 410, a display portion determining module 412, an evaluation module 414, and an output module 416. The memory 304 may also comprise other modules 418 to perform various miscellaneous functionalities of the control unit 202 of the electronic device 200. It will be appreciated that such aforementioned modules may be represented as a single module or a combination of different modules.

In an embodiment, the receive module 312 receives the contextual parameters and/or the non-contextual parameters. The contextual parameters includes, without limitations, the user parameters which in turn include, but is not limited to, the user gestures performed on the display 100, the information of the display 100 and the one or more portions of the display 100 being viewed by the users, the number of the users viewing the display 100 or present in front of the display and the distance value of the users with respect to the display 100. Particularly, the user parameters including the information of the display 100 being viewed by the user and/or the one or more portions are being viewed by the user is considered for controlling the resolution of the display 100 and/or the one or more portions. The number of users present in front of the display 100 and the distance value of the users from the display 100 are considered for resolution control. The ambient parameters including the lighting condition of the environment around the display 100 are considered for resolution control of the display 100. The content parameters refers to the one or more contents, for example, videos, images etc. viewed by the users and the contents being displayed on the display 100 are considered for resolution control of the one or more contents. For example, a black sky cannot be distinguished for lower resolution by naked eye and hence can be displayed with lower resolution while a bight human face can be rendered at a higher resolution for viewing by the user. The user parameters further includes user emotions i.e. response of the user towards the one or more content being displayed, or the one or more portions or the display 100.

The non-contextual parameters include, without limitations, the power consumption parameters and the predefined resolution settings. The power consumption parameters refers to the battery life of the display 100 and/or the electronic device 200 associated to the display 100. The predefined resolution settings comprise the preferences of the users for viewing the one or more portions of the display 100 and the one or more contents being displayed on the display 100.

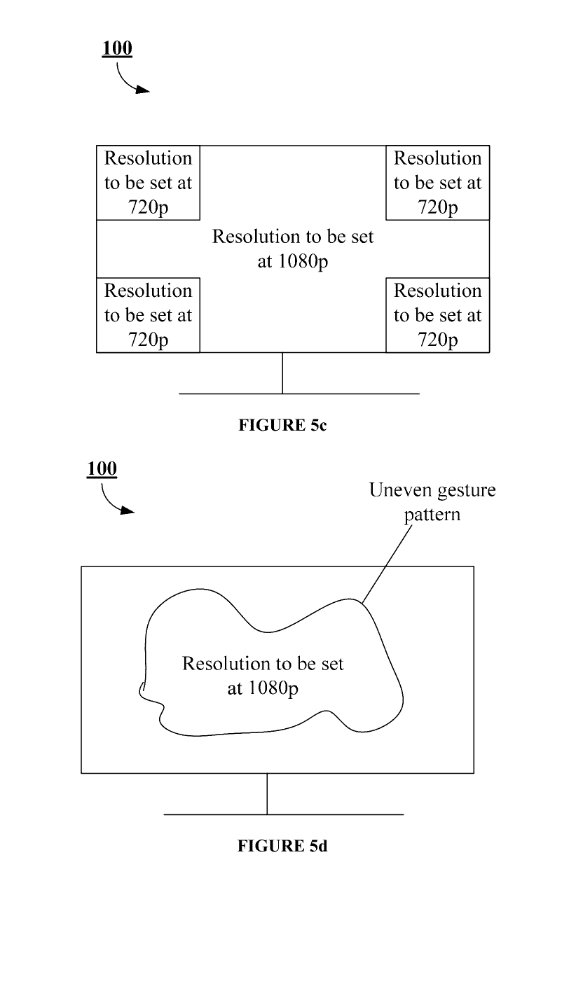

FIG. 5a shows an exemplary diagram illustrating static resolution control. For example, consider the display 100 displays movies or photos. Now, assuming, the resolution of the one or more portions are predefined. For example, the upper portion numbered as 502 is predefined with resolution of 1080p and lower portion numbered as 504 is predefined with resolution of 720p. Then, the resolutions of the portions 502 and 504 are modified to be of 1080p and 720p respectively. FIG. 5b shows a diagram where the user swipes on the display 100 to make left corner portion of the display 100 with resolution of 1080p and other rest portion with resolution of 720p. Such selection of the portions are dynamically performed which are not predefined. FIG. 5c shows a diagram where four corner portions of the display 100 is set with resolution of 720p based on less viewing by the users and middle portion of the display 100 with resolution of 1080p based on more viewing by the users. FIG. 5d shows the user gestures of uneven gesture pattern where the user wishes to set the resolution of 1080p within the uneven gesture pattern drawn by the user.

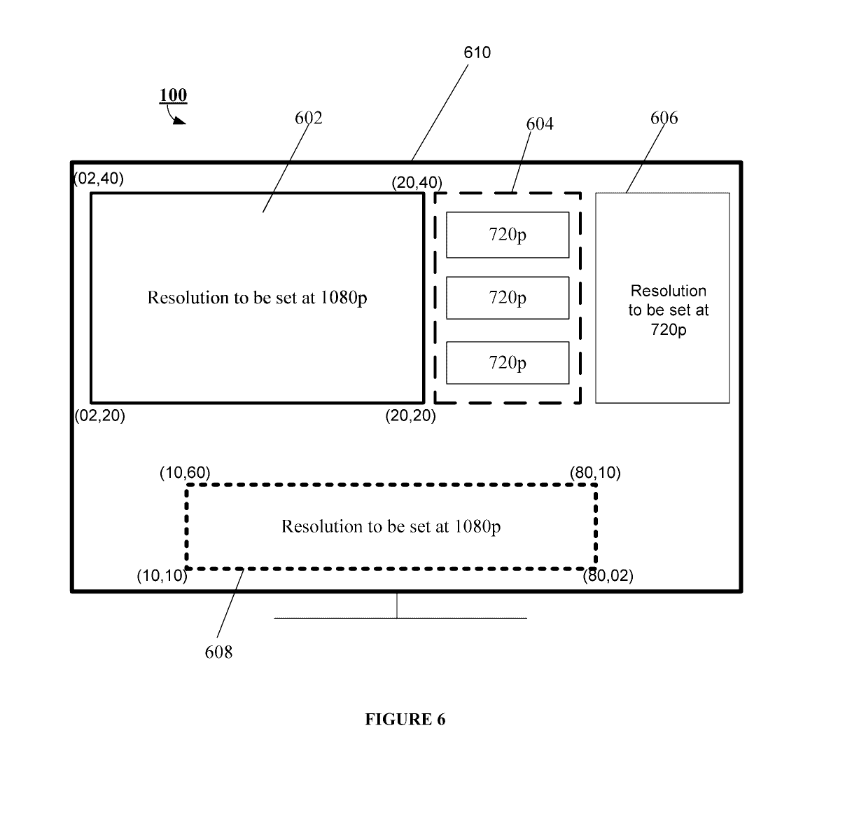

Referring back to FIG. 4, the display portion determining module 412 determines the one or more portions of the display 100 to be selected based on the received contextual parameters and the non-contextual parameters. In an embodiment, the display portion determining module 412 calculates pixel coordinates of the display 100 based on the received contextual parameters and the non-contextual parameters. FIG. 6 shows an exemplary diagram of the display 100 having the one or more portions numbered as 602, 604, 606, 608 and 610. The portion 610 depicts the entire display 100. Considering, the portions 602 and 608 are to be selected based on the received contextual parameters and the non-contextual parameters. Then, the pixel coordinates of the portions 602 and 608 respectively are calculated which are shown in FIG. 6. Upon calculating the pixel coordinates, the portions 602 and 608 are selected for controlling resolution of the portions 602 and 608 respectively.

The evaluation module 414 evaluates the resolution to be applied for the selected one or more portions of the display 100 and/or the entire display 100 itself. The evaluation module 414 evaluates the resolution for each of the selected one or more portions based on the received contextual parameters and the non-contextual parameters. For example, if the user performs some gesture patterns on the display 100 then the portions formed from the gesture patterns are selected. Then, the resolution of the selected portions is modified. From illustrated FIG. 6, the resolutions of the portions 602 and 608 are modified based on the received contextual parameters and the non-contextual parameters. Consider a scenario, if the display is being viewed by the user and/or the one or more portions are being viewed by the user, then the display 100 and/or the one or more portions being viewed by the user are selected. Then, the resolution of the display 100 itself and/or the one or more portions are increased. In the alternative, if the display 100 and/or the one or more portions are not being viewed by the user, then the resolution of the display 100 and/or the one or more portions are reduced. The modification of the resolution of the display 100 and/or the one or more portions also depends on the number of the user viewing the display 100 and/or the one or more portions. For example, if no user is present in front of the display 100 or if no user is viewing the display then the resolution of the display 100 is reduced or the display 100 is shut off. The resolution control depends on the user emotions as well. For example, if the user is feeling uneasy to percept the resolution of the display 100, then the resolution of the display 100 is modified as per user eye perception. The resolution of the display 100 and/or the one or more portions also depends on the distance value of the users from the display 100. For example, if the users are present beyond a certain distance limit then the resolution of the display 100 is reduced to low resolution. If the user is close to the display 100 then the resolution of the display 100 is set to high resolution. If the lighting condition of environment around the display 100 is bright or dark then the resolution of the display 100 is adjusted as per user's eye perception. If a particular content is being regularly viewed by the user and/or displayed on the display 100, then the resolution of the particular content is adjusted to be more for user's visibility. If the power consumed by the display 100 and/or the electronic device is more, then the resolution of the display 100 and/or the one or more portions are reduced. If the user has predefined preferences of resolution of each of the display 100 and/or each portion of the one or more portions and/or the content to be viewed, then the resolution of each of the display 100 and/or each portion of the one or more portions and/or the content to be viewed is modified based on the predefined preferences. Hence, based on the above mentioned parameters, the resolution to be applied for each of the one or more portions and/or the display 100 is evaluated. The evaluated resolution to be applied is provided to a graphic controller of the electronic device for dynamically controlling the resolution of the one or more portions and/or the display 100. The graphic controller can be in-built and/or configured in the display 100 itself.

The output module 416 provides the evaluated resolution of each of the one or more portions of the display 100 to the graphic controller 204 of the electronic device 200 for controlling the resolution of the one or more portions and/or the display 100.

The other modules 418 processes all such operations required to dynamically control the resolution of the one or more portions of the display 100 and/or the display 100 itself.

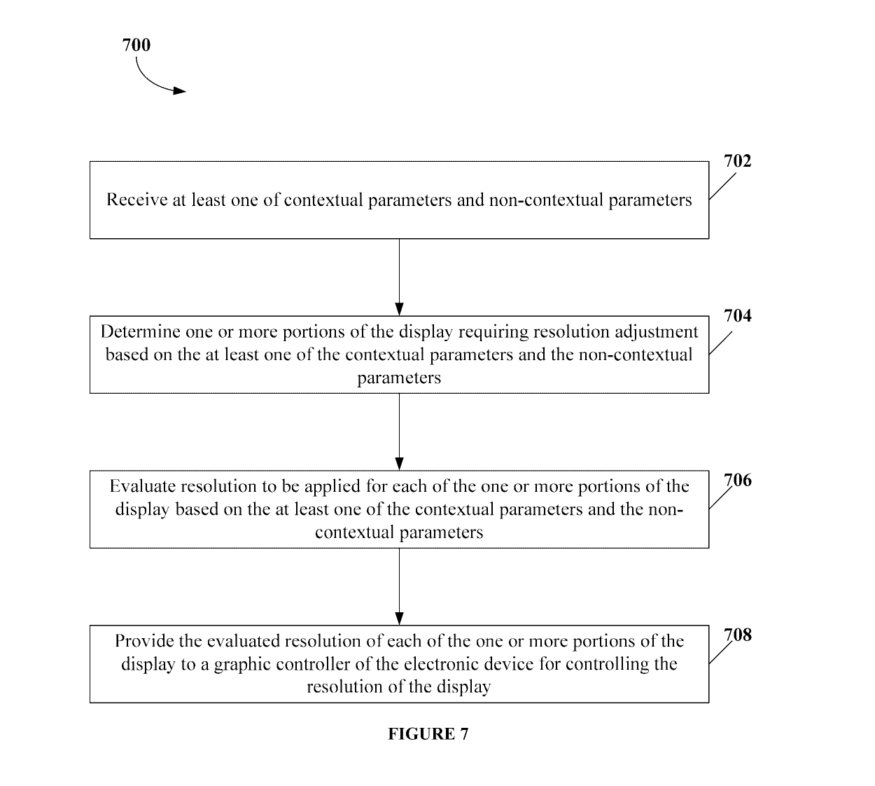

FIG. 7 shows a flowchart illustrating a method for dynamically controlling resolution of the one or more portions of the display 100 and/or the display 100 itself in accordance with some embodiments of the present disclosure.

As illustrated in FIG. 7, the method comprises one or more blocks for dynamically controlling resolution of the one or more portions of the display 100. The method may be described in the general context of computer executable instructions. Generally, computer executable instructions can include routines, programs, objects, components, data structures, procedures, modules, and functions, which perform particular functions or implement particular abstract data types.

The order in which the method is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 702, the control unit 202 of the electronic device 200 receives the contextual parameters and/or the non-contextual parameters. In an embodiment, the contextual parameters comprise the user parameters, the ambient parameters and the content parameters along with user emotions. The user parameters includes, without limitations, the user gestures on the display 100, information of the display and/or the one or more portions of the display 100 being viewed by users, the number of the users viewing the display 100 and the distance value of the users with respect to the display 100. The ambient parameters comprise the lighting conditions of environment around the display 100. The content parameters comprise the one or more contents viewed by users, and the one or more contents displayed on the display 100. The non-contextual parameters include, without limitations, the power consumption parameters and the predefined resolution settings. The power usage parameters comprise information of power consumption of the display 100 and/or the electronic device 200 associated to the display 100. The predefined resolution settings comprise preferences of the users for viewing the one or more portions of the display 100 and the one or more contents displayed on the display 100.

At block 704, the one or more portions of the display 100 requiring resolution adjustment are determined based on the contextual parameters and/or the non-contextual parameters. In an embodiment, the one or more portions of the display 100 are determined upon calculating pixel coordinates of the display 100 based on the contextual parameters and/or the non-contextual parameters.

At block 706, resolution to be applied for each of the one or more portions of the display 100 are evaluated based on the contextual parameters and/or the non-contextual parameters.

At block 708, the evaluated resolution of each of the one or more portions of the display 100 to the graphic controller 204 of the electronic device 200 is provided for controlling the resolution of the display 100.

### Computer System

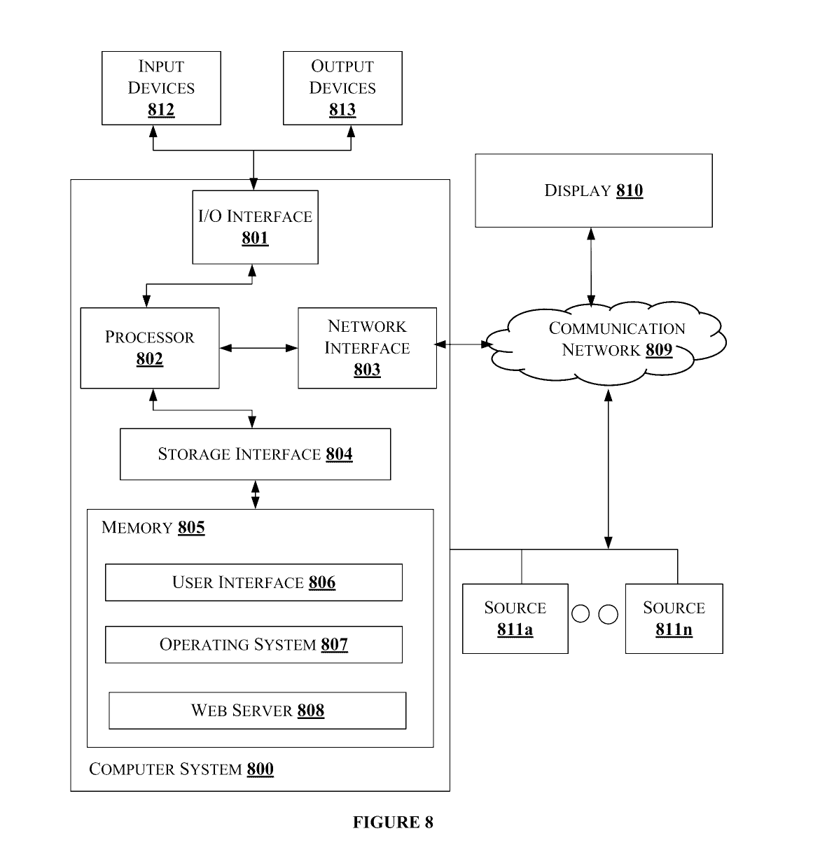

FIG. 8 illustrates a block diagram of an exemplary computer system 800 for implementing embodiments consistent with the present disclosure. In an embodiment, the computer system 800 is used to implement the control unit 202 of the electronic device 200. The computer system 800 dynamically controls the resolution of the one or more portions of the display 100 and/or the display 100. The computer system 800 may comprise a central processing unit (“CPU” or “processor”) 802. The processor 802 may comprise at least one data processor for executing program components for executing user- or device-generated multimedia content. The processor 802 may include specialized processing units such as integrated system (bus) controllers, memory management control units, floating point units, graphics processing units, digital signal processing units, etc.

The processor 802 may be disposed in communication with one or more input/output (I/O) devices (not shown) via I/O interface 801. The I/O interface 801 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 801, the computer system 800 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The computer system 800 comprises graphic controller (not shown) to set the resolution of the display 810.

In some embodiments, the computer system 800 is connected to the one or more sources 811a, . . . , 811n which is similar to the one or more sources 206 and the display 810 which depicts the display 100 through a communication network 809. The processor 802 may be disposed in communication with the communication network 809 via a network interface 803. The network interface 803 may communicate with the communication network 809. The network interface 803 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 809 may include, without limitation, a direct interconnection, local area network (LAN), wide area network (WAN), wireless network (e.g., using Wireless Application Protocol), the Internet, etc. Using the network interface 803 and the communication network 809, the computer system 800 may communicate with the broadcasting server 810. The network interface 803 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 809 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example. Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 802 may be disposed in communication with a memory 805 (e.g., RAM, ROM, etc. not shown in FIG. 8) via a storage interface 804. The storage interface 804 may connect to memory 805 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 805 may store a collection of program or database components, including, without limitation, user interface 806, an operating system 807, web server 808 etc. In some embodiments, computer system 800 may store user/application data 806, such as the data, variables, records, etc. as described in this disclosure. Such databases may be implemented as fault-tolerant, relational, scalable, secure databases such as Oracle or Sybase.

The operating system 807 may facilitate resource management and operation of the computer system 800. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

In some embodiments, the computer system 800 may implement a web browser 807 stored program component. The web browser 808 may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers 808 may utilize facilities such as AJAX, DHTML, Adobe Flash, JavaScript, Java, Application Programming Interfaces (APIs), etc. In some embodiments, the computer system 600 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 600 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, nonvolatile memory, hard drives, CD ROMs, DVDs, flash drives, disks, and any other known physical storage media.

Advantages of the embodiment of the present disclosure are illustrated herein.

Embodiments of the present disclosure are related to resolution control of any portion of the display independent of one another. Hence, maintaining the uniform resolution is eliminated since any portion of the display can be set to any resolution as per convenience and perception of user.

Embodiments of the present disclosure reduce wastage of processing time and power consumption since the parameters of the user and device are basis for modifying the resolution of the portions of the display.

Embodiments of the present disclosure improve visual experience of the user by automatically adjusting resolution of the display.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 7 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| Number | Description |
| 100 | Display |
| 200 | Electronic Device |
| 202 | Control Unit |
| 204 | Graphic Controller |
| 206a, . . . , 206n | Sources |
| 300 | I/O Interface |
| 302 | Processor |
| 304 | Memory |
| 400 | Data |
| 402 | Contextual Parameters |
| 404 | Non-Contextual Parameters |
| 406 | Other Data |
| 408 | Modules |
| 410 | Receive Module |
| 412 | Display Portion Determining Module |
| 414 | Evaluation Module |
| 416 | Output Module |
| 418 | Other Modules |
| 800 | Computer System |
| 801 | I/O Interface |
| 802 | Processor |
| 803 | Network Interface |
| 804 | Storage Interface |
| 805 | Memory |
| 806 | User interface |
| 807 | Operating System |
| 808 | Web Server |
| 809 | Communication Network |
| 810 | Display |
| 811a, . . . , 811n | Sources |
| 812 | Input Devices |
| 813 | Output Devices |

What is claimed is:

1. A method for dynamically controlling resolution of a display associated to an electronic device, the method comprising:
receiving, by a control unit of the electronic device, at least one of contextual parameters and non-contextual parameters;
determining, by the control unit, one or more portions of the display requiring resolution adjustment based on the at least one of the contextual parameters and the non-contextual parameters;
evaluating, by the control unit, resolution to be applied for each of the one or more portions of the display based on the at least one of the contextual parameters and the non-contextual parameters; and
providing, by the control unit, the evaluated resolution of each of the one or more portions of the display to a graphic controller of the electronic device for controlling the resolution of the display.

2. The method as claimed in claim 1, wherein the at least one of the contextual parameters and the non-contextual parameters are received from one or more sources communicatively connected to the control unit.

3. The method as claimed in claim 1, wherein the contextual parameters comprises at least one of user parameters, ambient parameters, and content parameters.

4. The method as claimed in claim 3, wherein the user parameters comprise at least one of user gestures on the display, information of at least one of the display and portions of the display being viewed by users, number of the users viewing the display and distance value of the users with respect to the display.

5. The method as claimed in claim 3, wherein the ambient parameters comprise lighting conditions of environment around the display.

6. The method as claimed in claim 3, wherein the content parameters comprise at least one of content viewed by users, and content displayed on the display.

7. The method as claimed in claim 1, wherein the non-contextual parameters comprises at least one of power usage parameters and predefined resolution settings.

8. The method as claimed in claim 7, wherein the power usage parameters comprise information of power consumption of at least one of the display and a device associated to the display.

9. The method as claimed in claim 7, wherein the predefined resolution settings comprise preferences of user for viewing the one or more portions of the display and the content displayed on the display.

10. A control unit of an electronic device for dynamically controlling resolution of a display associated to the electronic device, comprising:
a processor;
a memory communicatively coupled to the processor, wherein the memory stores processor-executable instructions, which, on execution, cause the processor to:
receive at least one of contextual parameters and non-contextual parameters;
determine one or more portions of the display requiring resolution adjustment based on the at least one of the contextual parameters and the non-contextual parameters;
evaluate resolution to be applied for each of the one or more portions of the display based on the at least one of the contextual parameters and the non-contextual parameters; and
provide the evaluated resolution of each of the one or more portions of the display to a graphic controller of the electronic device for controlling the resolution of the display.

11. The control unit as claimed in claim 10 is communicatively connected to one or more source, wherein the at least one of the contextual parameters and the non-contextual parameters are received from the one or more sources.

12. The control unit as claimed in claim 10, wherein the contextual parameters comprises at least one of user parameters, ambient parameters, and content parameters.

13. The control unit as claimed in claim 12, wherein the user parameters comprise at least one of user gestures on the display, information of at least one of the display and portions of the display being viewed by users, number of the users viewing the display and distance value of the users with respect to the display.

14. The control unit as claimed in claim 12, wherein the ambient parameters comprise lighting conditions of environment around the display.

15. The control unit as claimed in claim 12, wherein the content parameters comprise at least one of content viewed by users, and content displayed on the display.

16. The control unit as claimed in claim 10, wherein the non-contextual parameters comprises at least one of power usage parameters and predefined resolution settings.

17. The control unit as claimed in claim 16, wherein the power usage parameters comprise information of power consumption of at least one of the display and a device associated to the display.

18. The control unit as claimed in claim 16, wherein the predefined resolution settings comprise preferences of user for viewing the one or more portions of the display and the content displayed on the display.

19. A non-transitory computer readable medium including instructions stored thereon that when processed by a processor cause a control unit of an electronic device for dynamically controlling resolution of a display associated to the electronic device by performing acts of:
receiving at least one of contextual parameters and non-contextual parameters;
determining one or more portions of the display requiring resolution adjustment based on the at least one of the contextual parameters and the non-contextual parameters;
evaluating resolution to be applied for each of the one or more portions of the display based on the at least one of the contextual parameters and the non-contextual parameters; and
providing the evaluated resolution of each of the one or more portions of the display to a graphic controller of the electronic device for controlling the resolution of the display.
